(19) United States
(12) Patent Application Publication
(10) Pub. No.: US 2019/0322195 A1
(43) Pub. Date: Oct. 24, 2019

(54) Liftable Backrest Assembly for Automotive Vehicle

(71) Applicants: Chia-Jung Chang, Tainan City (TW); Kuan-Lung Huang, Tainan City (TW)

(72) Inventors: Chia-Jung Chang, Tainan City (TW); Kuan-Lung Huang, Tainan City (TW)

(21) Appl. No.: 15/955,801

(22) Filed: Apr. 18, 2018

(51) Int. Cl. B60N 2/22; B62J 1/28

(52) U.S. Cl. CPC B60N 2/2222; B60N 2/2245; B60N 2205/35; B60N 2002/2204; B62J 1/28

(57) ABSTRACT

A backrest assembly includes a backrest (10), a support unit (11) and a fixture (12). The backrest is provided with an adjusting member (100). The support unit includes a front support (110), a rear support (111) and a plurality of joints (112). The rear support has a first end connected with one of the joints and combined with the fixture and a second end connected with another one of the joints and combined with a first end of the front support. The front support has a second end connected with another one of the joints and combined with the backrest. The backrest assembly is attached to an automotive vehicle by the fixture. The front support and the rear support form an angle and are locked by the joints.

### BACKGROUND OF THE INVENTION

### 1. Field of the Invention

The present invention relates to a backrest and, more particularly, to a backrest assembly for an automotive vehicle.

### 2. Description of the Related Art

A conventional automotive vehicle, such as a car or the like, comprises a backrest mounted on a seat to support a driver's back, so as to provide a comfortable sensation to the driver. However, the backrest is located at the middle position of the seat, thereby causing inconvenience to the driver when getting on or off the automotive vehicle.

### BRIEF SUMMARY OF THE INVENTION

The primary objective of the present invention is to provide a liftable backrest assembly for an automotive vehicle, to facilitate a driver getting on or off the automotive vehicle.

In accordance with the present invention, there is provided a backrest assembly comprising a backrest, a support unit and a fixture. The backrest is provided with an adjusting member. The support unit includes a front support, a rear support and a plurality of joints. The rear support of the support unit has a first end connected with one of the joints and combined with the fixture and a second end connected with another one of the joints and combined with a first end of the front support. The front support of the support unit has a second end connected with another one of the joints and combined with the backrest. The fixture is secured to an automotive vehicle to attach the backrest assembly to the automotive vehicle. The front support and the rear support of the support unit form an angle and are locked by the joints of the support unit.

Preferably, the fixture of the backrest assembly is secured to a frame of the automotive vehicle.

Preferably, when the backrest assembly is mounted on a car, the first end of the rear support of the support unit is secured to a body of the car by one of the joints.

Preferably, the adjusting member locks or unlocks the joints of the support unit to adjust the angle formed by the front support and the rear support of the support unit.

According to the primary advantage of the present invention, the backrest assembly rests on and supports the driver's back, to provide a comfortable sensation to the driver during a long travel.

According to another advantage of the present invention, the angle of the backrest is adjusted according to the user's practical requirement.

According to a further advantage of the present invention, the backrest assembly is assembled and operated easily and conveniently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a backrest assembly in accordance with the preferred embodiment of the present invention.

FIG. 2 is a perspective assembly view of the backrest assembly as shown in FIG. 1.

FIG. 3 is a perspective view showing the backrest assembly for a motorcycle.

FIG. 4 is a schematic operational view of the backrest assembly as shown in FIG. 3.

FIG. 5 is a schematic operational view of the backrest assembly as shown in FIG. 4.

FIG. 6 is a schematic operational view of the backrest assembly as shown in FIG. 5.

FIG. 7 is a schematic operational view of the backrest assembly as shown in FIG. 4.

FIG. 8 is a schematic view showing the backrest assembly for a car.

FIG. 9 is a schematic operational view of the backrest assembly as shown in FIG. 8.

FIG. 10 is a schematic operational view of the backrest assembly as shown in FIG. 9.

### DETAILED DESCRIPTION OF THE INVENTION

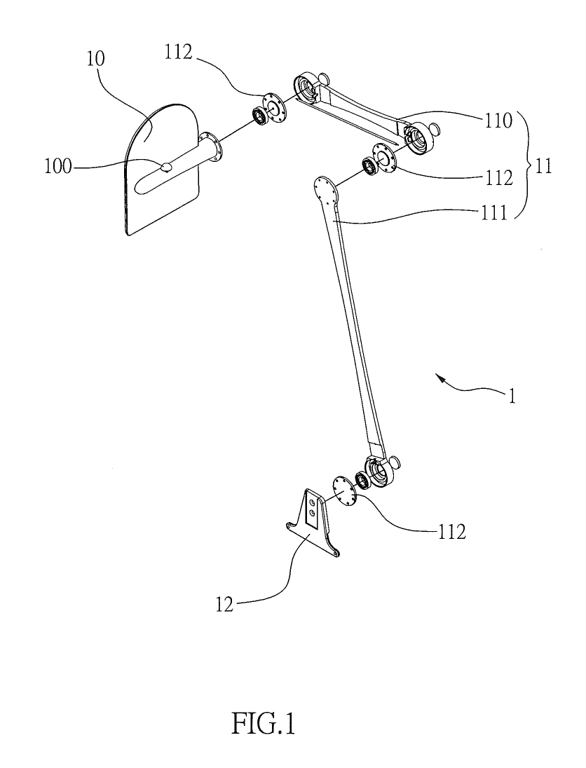

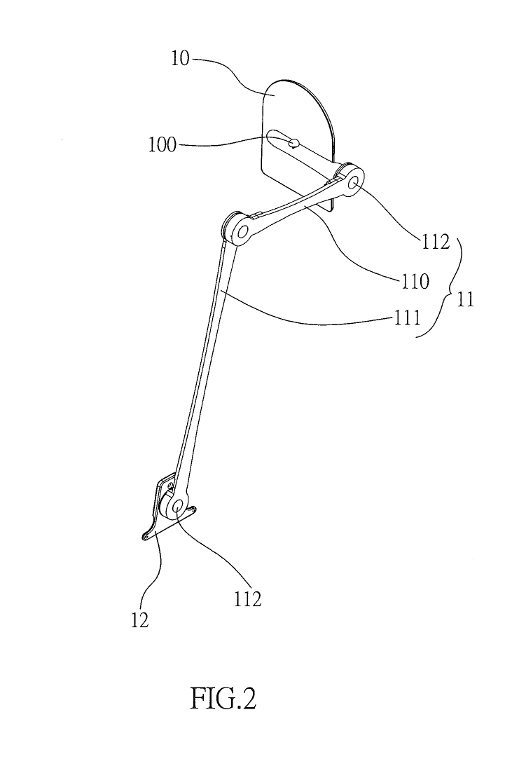

Referring to the drawings and initially to FIGS. 1 and 2, a backrest assembly 1 in accordance with the preferred embodiment of the present invention comprises a backrest 10, a support unit 11 and a fixture 12. The backrest 10 has a rear part provided with an adjusting member 100. The support unit 11 includes a front support 110, a rear support 111 and a plurality of joints 112. The rear support 111 of the support unit 11 has a first end connected with one of the joints 112 and combined with the fixture 12 and a second end connected with another one of the joints 112 and combined with a first end of the front support 110. The front support 110 of the support unit 11 has a second end connected with another one of the joints 112 and combined with the backrest 10.

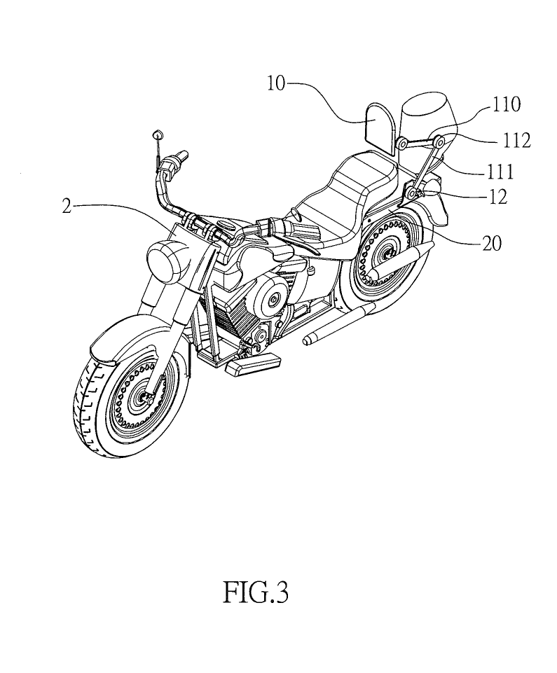

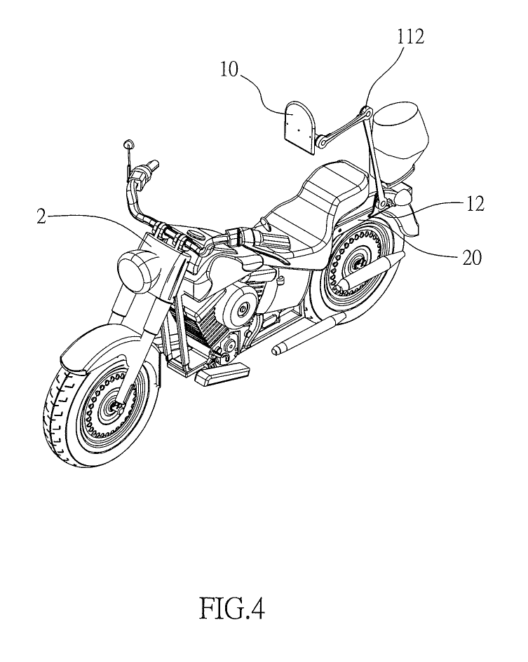

Referring to FIGS. 3 and 4, the fixture 12 is secured to a frame 20 of an automotive vehicle 2 by screwing to attach the backrest assembly 1 to the automotive vehicle 2. The front support 110 and the rear support 111 are releasably locked by the joints 112, so that the backrest 10 is pulled forward to a predetermined position of the automotive vehicle 2.

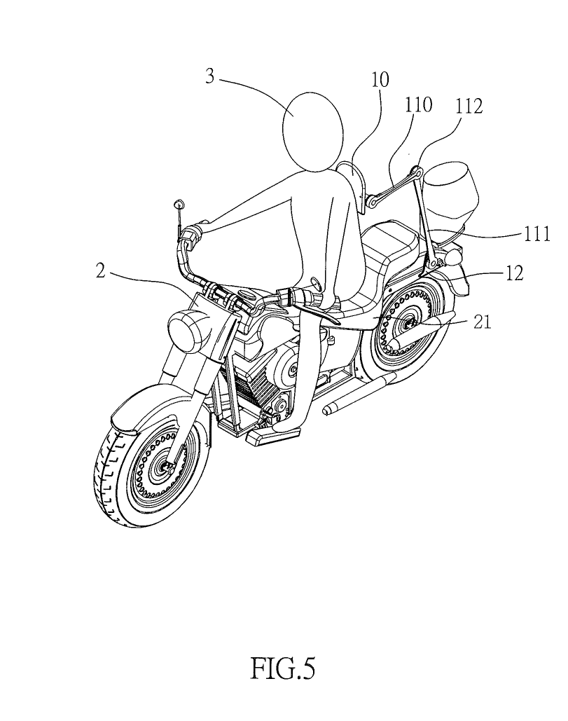

Referring to FIG. 5, when a driver 3 is seated on the automotive vehicle 2, the backrest 10 is pulled forward to the middle position of a seat 21 of the automotive vehicle 2 so as to support the back of the driver 3. At this time, the front support 110, the rear support 111 and the fixture 12 form an angle and are locked by the joints 112 of the support unit 11.

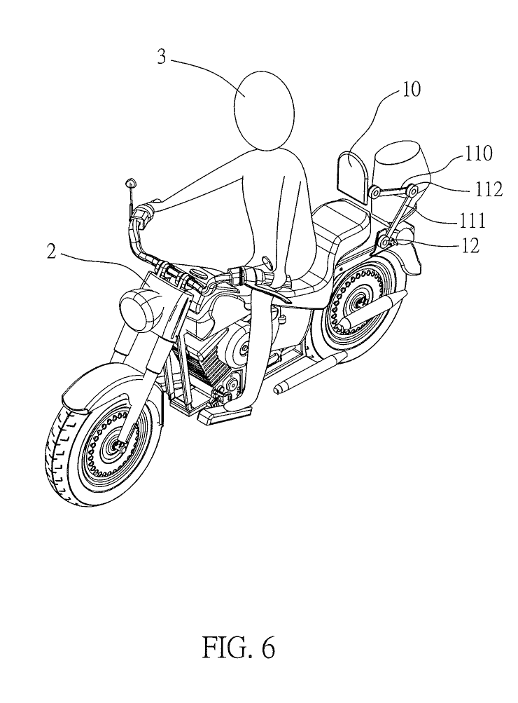

Referring to FIG. 6, the adjusting member 100 of the backrest 10 is pushed to release and unlock the joints 112 of the support unit 11, so that the front support 110 and the rear support 111 are moved backward to the original position, to facilitate the driver 3 getting off the automotive vehicle 2.

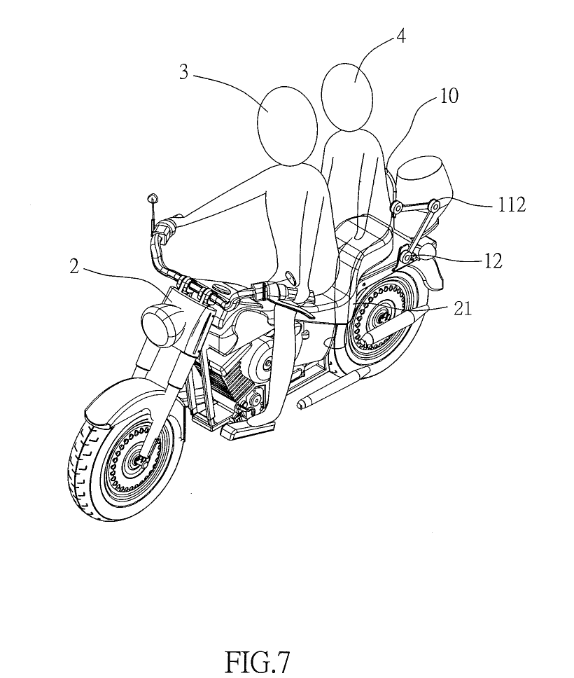

Referring to FIG. 7, when a passenger 4 is seated on the automotive vehicle 2 and located behind the driver 3, the backrest 10 is pulled forward and adjusted to the rear position of the seat 21 of the automotive vehicle 2 so as to support the waist or hip of the passenger 4. At this time, the front support 110, the rear support 111 and the fixture 12 form an angle and are locked by the joints 112 of the support unit 11.

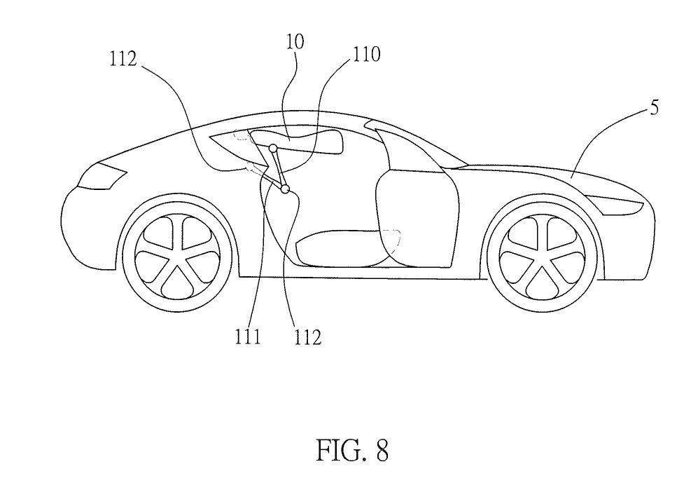

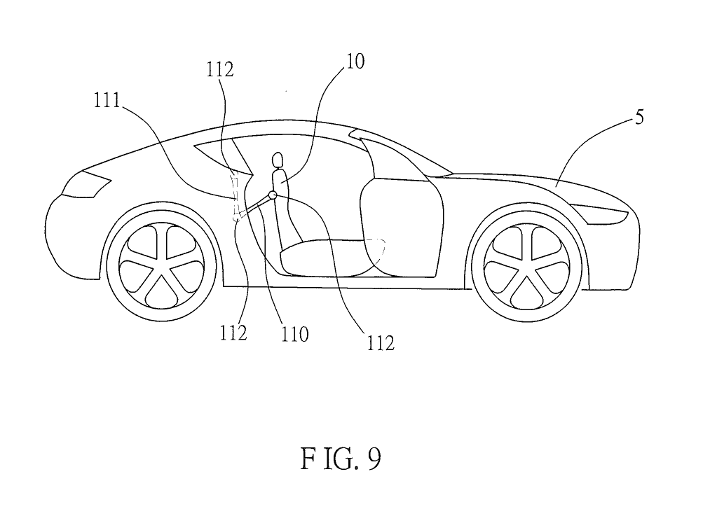

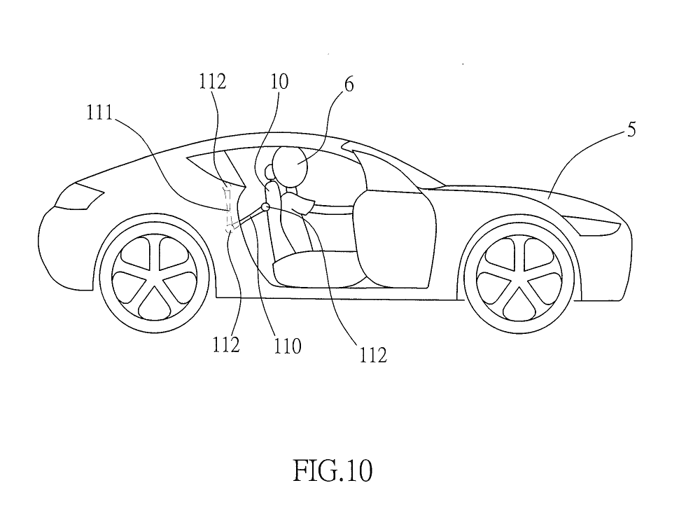

Referring to FIGS. 8-10, when the backrest assembly 1 is mounted on a car 5, the first end of the rear support 111 of the support unit 11 is secured to the body of the car 5 by one of the joints 112, and the backrest 10 is pulled forward to adjusted to a proper position of the car 5 so as to support the back of a driver 6. At this time, the front support 110 and the rear support 111 form an angle and are locked by the joints 112 of the support unit 11. After the adjusting member 100 (not shown) of the backrest 10 is pushed to release and unlock the joints 112 of the support unit 11, the backrest 10 is moved upward and backward to facilitate the driver 6 getting off the car 5.

Accordingly, the backrest assembly 1 rests on and supports the driver's back, to provide a comfortable sensation to the driver during a long travel. In addition, the angle of the backrest 10 is adjusted according to the user's practical requirement. Further, the backrest assembly 1 is assembled and operated easily and conveniently.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A backrest assembly comprising:
a backrest (10), a support unit (11) and a fixture (12);
wherein:
the backrest is provided with an adjusting member (100);
the support unit includes a front support (110), a rear support (111) and a plurality of joints (112);
the rear support of the support unit has a first end connected with one of the joints and combined with the fixture and a second end connected with another one of the joints and combined with a first end of the front support;
the front support of the support unit has a second end connected with another one of the joints and combined with the backrest;
the fixture is secured to an automotive vehicle to attach the backrest assembly to the automotive vehicle; and
the front support and the rear support of the support unit form an angle and are locked by the joints of the support unit.

2. The backrest assembly of claim 1, wherein the fixture of the backrest assembly is secured to a frame (20) of the automotive vehicle.

3. The backrest assembly of claim 1, wherein when the backrest assembly is mounted on a car (5), the first end of the rear support of the support unit is secured to a body of the car by one of the joints.

4. The backrest assembly of claim 1, wherein the adjusting member locks or unlocks the joints of the support unit to adjust the angle formed by the front support and the rear support of the support unit.
